(19) United States
(12) Patent Application Publication
(10) Pub. No.: US 2026/0259530 A1
(43) Pub. Date: Sep. 3, 2026

(54) MECHANISM FOR ANIMATING AN OBJECT FOR A TIMEPIECE

(71) Applicant: GREUBEL FORSEY S. A., La Chaux-de-Fonds (CH)

(72) Inventors: Stephen FORSEY, Les Brenets (CH); Florian CORNEILLE, Mathay (FR); Anaïs HAMEL, La Chaux-de-Fonds (CH)

(21) Appl. No.: 18/718,376

(22) PCT Filed: Dec. 14, 2022
(86) PCT No.: PCT/EP2022/085828

§ 371 Date: Jun. 10, 2024

(30) Foreign Application Priority Data
Dec. 21, 2021 (EP) 21216235.8

(51) Int. Cl. G04B 47/04

(52) U.S. Cl. CPC G04B 47/044; G04B 47/042

(57) ABSTRACT

Mechanism (1) for animating an object (7) for a portable timepiece, comprising a frame element (3) on which are mounted:
a drive source (5) ;
a drive wheel (12) arranged to be driven by sald drive source (5) and defining a main pivot axis (A) about which said drive wheel (12) is arranged to pivot;
a drive element (15) rotationally integrated with said drive wheel (12) and arranged to drive said object (7) in rotation about said main pivot axis (A);
a turntable (17) arranged coaxially with said drive wheel (12) and carrying a support system (13) for said object, said support system (13) being off-center with respect to said main pivot axis (A),
wherein said support system (13) comprises a first frame (13b) pivotally mounted on said turntable (17) about said first pivot axis (A1), as well as an inner frame (13f) pivotally mounted in said first frame (13b) about a second pivot axis (A2) which is substantially orthogonal to said first pivot axis (A1),
and wherein said object (7) is carried by a shaft (13h) pivotally mounted in said inner frame (13f) about a third pivot axis (A3), said shaft (13h) being rotationally integrated with a pinion (13l) meshing with a toothing (19a) which is coaxial with said driving wheel, said toothing (19a) being fixed or arranged to be rotated.

### TECHNICAL FIELD

The present invention relates to the field of watchmaking. More particularly, it concerns a mechanism for animating at least one object such as one or more jewels, one or more precious or semi-precious stones, one or more sculptures or any other miniature object(s) or combination thereof, adapted to be integrated into a timepiece.

### STATE OF THE ART

Document FR2988866 describes a mechanism for animating a precious or semi-precious stone, in which a drive spring is arranged to animate the stone in a rotational movement about a single axis of rotation, by means of a flexible belt. The stone is mounted on a shaft by four claws or jaws, which hold it in place. However, the movement of the stone is monotonous, revealing only one of its faces, which always presents the same angle to the wearer and thus limits its visibility. Furthermore, the stone's scintillation is thus relatively limited, and the wearer is obliged to observe it from an acute angle in order to see more than its crown.

Document U.S. Pat. No. 4,734,895 describes a mechanism for animating a stone, arranged so that the latter rotates around the dial. To achieve this, the stone is attached to a lever mounted so that it pivots around the center of the movement, and movements of the user's wrist cause the stone to move under the effect of gravity. However, if the piece is not moving, the stone remains stationary.

The aim of the invention is, therefore, to propose an animation mechanism in which the above-mentioned shortcomings are at least partially overcome.

### DISCLOSURE OF THE INVENTION

More specifically, the invention relates to a mechanism for animating at least one object for a wearable timepiece, as defined in claim 1.

This mechanism comprises a frame element on which are mounted:
a driving source, such as a mainspring or an electric motor, a manual force input (arbor, trigger-piece or similar), an oscillating mass;
a drive wheel arranged to be driven by said drive source and defining a main pivot axis about which it is arranged to pivot;
a drive element rotationally integrated with said drive wheel and arranged to drive said object in rotation about said main pivot axis;
a turntable, which is coaxial with said drive wheel and carries a support system for said object, said support system being off-center with respect to said main pivot axis.

Said support system comprises a first frame pivotally mounted on said turntable about said first pivot axis, as well as an inner frame pivotally mounted in said first frame about a second pivot axis which is substantially orthogonal to said first pivot axis. Said object is carried by a shaft pivotally mounted in said inner frame about a third pivot axis, said shaft being rotationally integrated with a pinion meshing with a toothing which is coaxial with and distinct from said driving wheel, said toothing being fixed or arranged to be rotated. This toothing is typically carried by a secondary wheel.

By these means, an orbital movement of the object can be obtained, the object being inclined with respect to the main pivot axis and rotating around the third axis as it travels around the latter, thus increasing the visibility of the object. In addition, the degrees of freedom provided by the frames make it possible to compensate for manufacturing tolerances and thus avoid jamming of the mechanism and/or loss of engagement between said pinion and said toothing with which the latter meshes. In the case where the object is a cut stone, its movement optimizes scintillations, and the angle of inclination of the object can be easily predetermined by the constructor by modifying the diameter of said wheel and the angle of its teeth as well as that of the pinion, for example in order to optimize scintillations for a particular stone or to optimize the visibility of any object.

Advantageously, said drive element, which may be a lever, crank or the like, cooperates with one end of said shaft. The pinion is thus constrained to remain in engagement with the toothing with which it meshes, without any need to provide other means for this purpose.

Advantageously, the ratio of diameters between said pinion and said toothing is at least 5, preferably between 5 and 400, even more preferably between 5 and 50, and even more preferably between 5 and 20.

Advantageously, said turntable is located outside said frame element, surrounding it in its plane.

Advantageously, the mechanism further comprises a regulating system such as an escapement-balance-hairspring system, a tuning fork, a quartz system, a centrifugal regulator, a paddle wheel rotating in air or in a liquid, a mono-, bi- or tri-axial tourbillon, a carrousel or the like, arranged to be driven by said driving source and thus regulate the rotational speed of said object.

The mechanism forming the object of the invention can, of course, be integrated into a timepiece, such as a wristwatch or pocketwatch, but also a table clock.

### BRIEF DESCRIPTION OF THE DRAWINGS

Further details of the invention will become clearer on reading the following description, made with reference to the appended drawings in which:

FIG. 1 is a schematic cross-sectional view of an animation mechanism according to the invention integrated into a timepiece;

FIG. 2 is an isometric view of the support system and the object supported by it; and

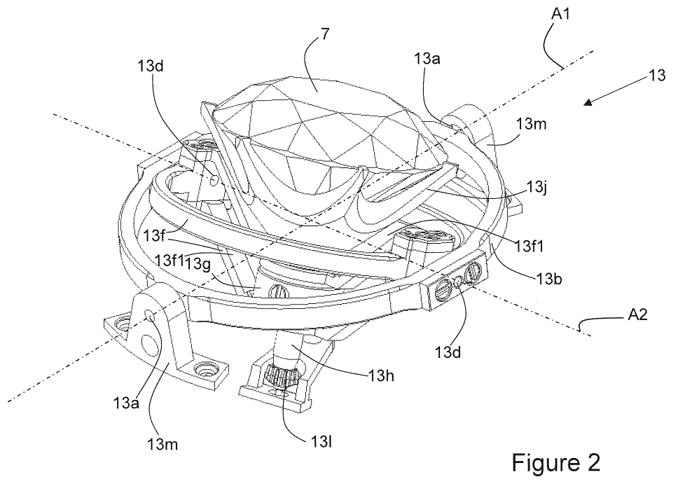

FIG. 3 is a cross-sectional view of the support system and the object supported by it.

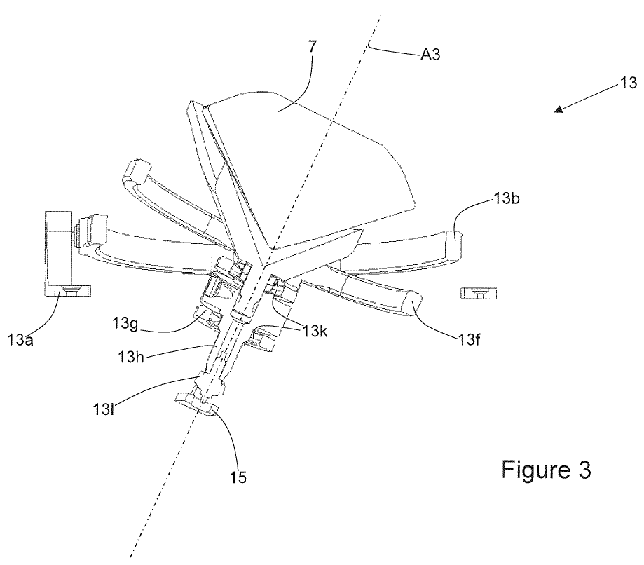

### EMBODIMENTS OF THE INVENTION

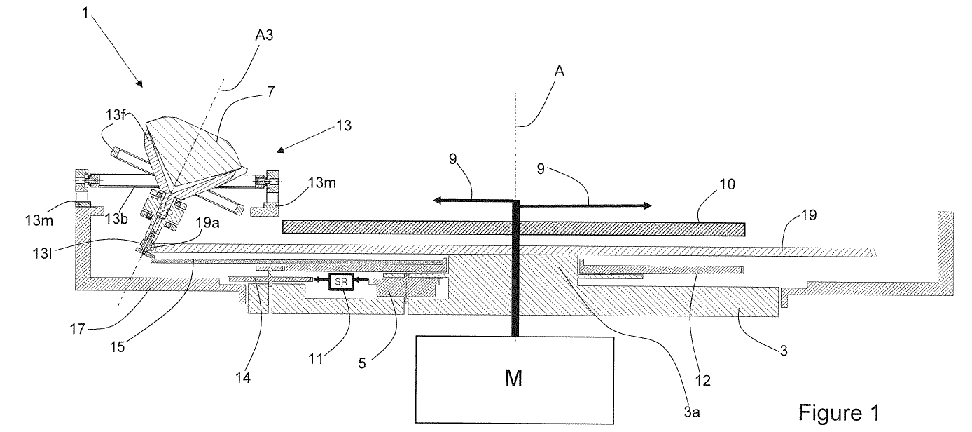

FIG. 1 illustrates an animation mechanism according to the invention integrated into a timepiece.

The animation mechanism 1 comprises a frame element 3 which serves as a support for the other components of said mechanism 1, and which can be fixed to the frame (e.g. on a plate or bridge) of a base movement M or can be integrated with such a frame. A drive source 5, such as a barrel housing a mainspring or a stepper motor, is mounted on the frame element 3 and is arranged to supply the energy required to drive the object 7. The driving source 5 may be dedicated to the animation mechanism 1, or may be shared with the watch movement M arranged to drive display elements 9 of any type and in any known manner, which surmount a dial 10 (if present). Alternatively, the driving source 5 may be an arbor, trigger-piece or the like, arranged to be manipulated by the user, or an oscillating mass.

The driving source 5 is preferably arranged to drive a regulating system 11 (particularly but not exclusively in the case where the driving source is a mainspring), which may be of any known mechanical type, such as, for example, a centrifugal regulator, a paddle wheel rotating in air or liquid, a tuning fork regulator, an escapement-balance-hairspring regulator, a mono-, bi- or tri-axial tourbillon, a carousel or any other similar system (or combination of systems). In the case of a stepper motor, the regulating system 11 may also be electric or electronic (e.g. a quartz regulator).

The driving force, regulated by the regulating system 11, rotates a drive wheel 12 pivotally mounted on the frame element 3, for example on a cylindrical bearing surface 3a of the latter, by means of a ball bearing or any other known type of bearing. The nature of the kinematic connection between the drive source 5 and the drive wheel 12 is not important, and can take any suitable form by being composed of wheels, pinions, belts, chains, combinations of these etc. In the illustrated construction, an intermediate mobile 14 is provided for this purpose.

A drive element 15 is rotatably mounted on the drive wheel 12, and serves to drive a support system 13 around the axis of rotation A of the latter, as will become clear later. In the illustrated construction, the drive element 15 is a lever, but it can also be a disk, a sector or the like, or can even be integrated into the drive wheel 12.

The support system 13, as well as the decorative object 7 (or several grouped decorative objects) which it carries, are off-center with respect to the axis A of the drive wheel, defined as the main pivot axis A (which is a geometric axis rather than a shaft). In the embodiment represented, the support system 13 and the decorative object 7 are not intersected by the axis A (i.e. they are distant from it), but the inverse can alternatively be the case. The support system 13 is thus arranged to perform an orbital movement around axis A. The object 7, and possibly also the entire support system 13, can be located so as not to be superimposed over the dial 10 (if present), such that these elements orbit around the latter. Alternatively, these elements may be at least partially superimposed on, or at least partially below, the dial 10.

The support system 13 is mounted, by means of a pair of pivots 13a carried by supports 13m, on a turntable 17 of annular shape, which is itself pivotally mounted on the frame element 3 by means of a ball bearing or any other suitable type of bearing. As a result, the turntable 17 surrounds the frame element 3. Alternatively, the turntable 17 can be of any shape, and/or can be pivoted on any shaft or bearing provided on the frame element 3.

The pivots 13a define a first pivot axis A1, about which is pivoted a first frame 13b constituted by an annular ring of generally circular shape. Other shapes (oval, square, rectangular, etc.) are also possible. This frame carries a pair of intermediate pivots 13d, which define a second pivot axis A2, substantially orthogonal to said first axis A1. An inner frame 13f is pivotally mounted about this second axis A2, and is integral with a base 13g which directly or indirectly carries the animated object 7. The inner frame 13f is composed of a part with a substantially circular shape, as well as two arms 13f1 which connect the pivots 13d to the base 13g. Needless to say, other shapes are also possible, and it is not even mandatory for the frame 13f to comprise the annular part. Indeed, the base 13g can simply be connected to the pivots by the arms 13f1 or by another suitable arrangement.

At least one of the frames 13b, 13f can be provided with a decoration, for example enameling, precious or semi-precious stones, or any other desired decoration. Furthermore, at least one of the shafts of the pivots 13d, 13a may protrude beyond the surface of the element through which it passes, i.e. the outer surface of the first frame 13b in the case of the pivots 13d, or the outer surface of the support 13m in the case of the pivots 13a, and may bear a decoration, such as a precious or semi-precious stone. The movement of this stone will thus generate scintillations which will accentuate the perception of the pivoting of the frame to which the stone is rotationally integrated.

It should also be noted that none of the frames 13b, 13f is superimposed on the animated object 7, which protrudes from these latter 13b, 13f, thus maximizing its visibility. In other words, at least part of said object 7 is further away from the drive element 15 than the entirity of the frames 13b, 13f.

In the illustrated embodiment, the animated object 7 is supported by a shaft 13h, which passes through the base 13g and is integral with a support 13j in which the animated object 7 is fixed by setting. Alternatively, the object 7 may be attached by gluing, screwing, welding, force-fitting or the like, depending on the nature of the object 7 and the support 13j, and it should be noted that the animated object 7 may be coaxial with the shaft 13h, or may be off-center with respect to this latter. Furthermore, the connection between the animated object 7 and the inner frame 13f may comprise a flexible element, for example made of elastomer, to allow the object to “float” slightly under the effect of the movement of the piece.

The shaft 13h is mounted in bearings 13k provided in the base 13g such that that said shaft 13h can pivot relative to the latter.

From the above, it is clear that the support system defines a gimbal support, which gives the animated object 7 two degrees of freedom in rotation, and substantially no degrees of freedom in translation. The rotation of the shaft 13h in the base 13g gives the animated object 7 a third degree of rotational freedom around a third axis A3, which corresponds to the geometric axis of the shaft 13h. Axis A3 is advantageously orthogonal to each of axes A1 and A2, but this is not mandatory.

The driving of the animated object 7 about the third axis A3 is ensured by the cooperation between a pinion 13l consisting of a toothing comprised by the shaft 13h and a bevel toothing 19a comprised by a secondary wheel 19 which is coaxial with the drive element 15 and is fixed in the illustrated construction. Other forms of gearing are also possible, such as an internal bevel gear borne by a crown wheel, or other suitable gears. In addition, the secondary gear 19 can also be rotated by a suitable mechanism to provide a rotation of the object 7 around axis A3 that is faster, slower and/or in the other direction than that obtained with a fixed secondary gear 19.

The drive element 15 cooperates with one end of the shaft 13h in such a way as to rotate the support system 13 as well as the turntable 17 about the axis A, while keeping the pinion 13l in engagement with the toothing 19a. In addition, drive element 15, or another element rotationally integrated with drive wheel 12, may also cooperate directly or indirectly with turntable 17, for example through cooperation between a pin and an oblong slot provided on these two elements. In yet another variant, not illustrated, the drive element 15 can cooperate with the turntable 17. In addition, other means may be provided to ensure gearing between pinion 131 and toothing 19a, as well as positioning of shaft 13h. To this end, one or more pressure springs mounted directly or indirectly on the turntable 17 can be cited.

By these means, the animated object 7 is rotated about the central axis A, while it pivots about its own pivot axis A3, the angle formed between these two axes remaining constant during the rotations. The object is thus made highly visible, and in the case of a stone, the scintillations can be accentuated.

At first glance, it might appear that the provision of rotation axes A1 and A2 is unnecessary. However, this is not the case. In view of the small size of pinion 131 (typically of the order of 0.10 to 1mm) and the relatively large diameter of secondary wheel 19 (typically of the order of 15 to 40mm), the usual tolerances as well as the operating backlashe of the gears make it difficult or even impossible to implement a support system 13 that only provides for pivot axis A3. Axes A1 and A2 are therefore necessary for the mechanism to operate correctly, to avoid any blocking or loss of meshing, particularly in the event of a shock.

In addition, the illustrated construction makes it easy to adapt the angle formed between axes A and A3 at the time of construction, for example in order to optimize the scintillation of a gemstone of any shape. To do this, the constructor can simply adapt the diameter of the secondary wheel 19, as well as the angle of mesh between pinion 131 and toothing 19a. In doing so, it is possible for axis A3 to intersect with the main pivot axis A on the dial side (i.e., towards an observer) or on the back side of the mechanism (i.e., the object points inwards or outwards respectively, depending on an observer's point of view).

In view of the above, it must be emphasized that the support system 13 is distinct from the regulating system 11, the latter serving merely to determine the speed of rotation of the drive wheel 12 and the movements of the animated object 7. In other words, the animated object 7 is not part of the regulating system 11 as a functional or support element, is not mounted on any element of the latter, does not carry any element of the regulating system 11 and can be considered kinematically in parallel with the latter.

In order to allow illumination of the object 7 from below (i.e. from the direction of the drive element 15), the support system 13 can be located within, or superimposed on, a polished well (not illustrated), which can take, for example, the form of a goblet, a parabolic, elliptical, or hemispherical mirror or similar, which is arranged to direct ambient light onto the underside of the object. Alternatively, a light source (e.g. a tritium element, one or more LEDs or the like) can be placed beneath the object and the frames 13b, 13f. By these means, if object 7 is a stone, its scintillations can be enhanced.

Although the invention has been previously described in connection with specific embodiments, other additional variants are also envisageable without departing from the scope of the invention as defined by the claims.

1.-6. (canceled)

7. Mechanism for animating at least one object for a portable timepiece, comprising a frame element on which are mounted:
a drive source;
a drive wheel arranged to be driven by said drive source and defining a main pivot axis about which said drive wheel is arranged to pivot;
a drive element rotationally integrated with said drive wheel and arranged to drive said object in rotation about said main pivot axis;
a turntable arranged coaxially with said drive wheel and carrying a support system for said object, said support system being off-center with respect to said main pivot axis,
wherein said support system comprises a first frame pivotally mounted on said turntable about said first pivot axis, as well as an inner frame pivotally mounted in said first frame about a second pivot axis which is substantially orthogonal to said first pivot axis,
and wherein said object is carried by a shaft pivotally mounted in said inner frame about a third pivot axis, said shaft being rotationally integrated with a pinion meshing with a toothing which is coaxial with said driving wheel, said toothing being fixed or arranged to be rotated.

8. Mechanism according to claim 7, wherein said drive element cooperates with one end of said shaft.

9. Mechanism according to claim 7, wherein the ratio of diameters between said pinion and said toothing is at least 5.

10. Mechanism according to claim 9, wherein the ratio of diameters between said pinion and said toothing is between 5 and 400.

11. Mechanism according to claim 10, wherein the ratio of diameters between said pinion and said toothing is between 5 and 50.

12. Mechanism according to claim 11, wherein the ratio of diameters between said pinion and said toothing is between 5 and 20.

13. Mechanism according to claim 7, wherein said turntable is located outside said frame element, considered in the plane of the latter.

14. Mechanism according to claim 7, further comprising a regulating system arranged to be driven by said driving source.

15. Timepiece comprising a mechanism according to claim 7.
